(19) United States
(12) Patent Application Publication
(10) Pub. No.: US 2020/0081452 A1
(43) Pub. Date: Mar. 12, 2020

(54) MAP PROCESSING DEVICE, MAP PROCESSING METHOD, AND COMPUTER READABLE MEDIUM

(71) Applicant: Mitsubishi Electric Corporation, Tokyo (JP)

(72) Inventor: Michinori YOSHIDA, Tokyo (JP)

(73) Assignee: Mitsubishi Electric Corporation, Tokyo (JP)

(21) Appl. No.: 16/603,143

(22) PCT Filed: Jun. 1, 2017
(86) PCT No.: PCT/JP2017/020450

§ 371 Date: Oct. 4, 2019

(51) Int. Cl. G05D 1/02; G01C 21/32; G01C 21/36; G06F 17/16; G06F 17/18

(52) U.S. Cl. CPC G05D 1/0274; G01C 21/32; G05D 2201/0213; G06F 17/16; G06F 17/18; G01C 21/3691

(57) ABSTRACT

A primary vector calculation unit calculates a sum of vectors for a target area with respect to a surrounding area as a primary vector of the target area, for each of a first map and a second map indicating existence probability that an object exists in each area, by using a difference between the existence probability for the target area and the existence probability for an adjacent area adjacent to the target area as a vector for the target area with respect to the adjacent area. A secondary vector calculation unit calculates a sum of the primary vector of each area included in an attention area as a secondary vector of the attention area. A determination unit compares the secondary vector calculated for the attention area for the first map with the secondary vector calculated for the attention area for the second map, to determine whether or not the attention area for the first map corresponds to the attention area for the second map.

### TECHNICAL FIELD

The present invention relates to a technique for associating a plurality of maps indicating existence probability that an object exists in each area.

### BACKGROUND ART

In order to obtain a wide range of map around a moving object such as a vehicle, a map acquired by the moving object may be synthesized with a map acquired by a moving object or a roadside device and the like existing in the vicinity. Patent Literatures 1 and 2 describe a method of synthesizing a map.

In Patent Literature 1, for each map, each grid is classified into an occupied grid, an unoccupied grid, and an unknown grid. For a window centered on the occupied grid, a histogram is created that represents the number of occupied, unoccupied, and unknown grids. On the basis of the histogram, corresponding points between the maps are specified. Then, coordinate conversion is performed such that the specified points are overlapped.

In Patent Literature 2, a distance between obstacle cells is calculated. Then, optimization processing is performed on a total value of the calculated distances, and coordinate conversion is performed.

### CITATION LIST

### Patent Literature

Patent Literature 1: JP 2005-326944 A

Patent Literature 2: JP 2009-157430 A

### SUMMARY OF INVENTION

### Technical Problem

The method described in Patent Literature 1 requires a lot of calculation processing and processing time since processing based on the histogram is performed. Further, in the method described in Patent Literature 2, noise becomes large when an obstacle moves, and synthesis accuracy becomes low.

An object of the present invention is to make it possible to accurately specify corresponding points between maps even when there is a moving object, while shortening a processing time.

### Solution to Problem

A map processing device according to the present invention includes:

a primary vector calculation unit to calculate a sum of a vector for a target area with respect to a surrounding area as a primary vector of the target area, for each of a first map and a second map indicating existence probability that an object exists in each area with at least a part of an area as the target area, by using a difference between the existence probability for the target area and the existence probability for an adjacent area adjacent to the target area as a vector for the target area with respect to the adjacent area;

a secondary vector calculation unit to calculate a sum of the primary vector of each area included in an attention area as a secondary vector of the attention area, for each of the first map and the second map with two or more areas as the attention area; and

a determination unit to compare the secondary vector calculated for the attention area for the first map and the secondary vector calculated for the attention area for the second map, to determine whether or not the attention area for the first map corresponds to the attention area for the second map.

### Advantageous Effects of Invention

In the present invention, corresponding points between maps are specified by comparing vectors, while using, as the vector, a difference of existence probability that an object exists in each area. This make it possible to accurately specify the corresponding points between the maps even when there is a moving object, while shortening the processing time.

### BRIEF DESCRIPTION OF DRAWINGS

FIG. 1 is a configuration diagram of a map processing device 10 according to a first embodiment.

FIG. 2 is a flowchart of overall processing of the map processing device 10 according to the first embodiment.

FIG. 3 is an explanatory view of a first map 31 and a second map 32 according to the first embodiment.

FIG. 4 is an explanatory view of a resolution change process according to the first embodiment.

FIG. 5 is a flowchart of a primary vector calculation process according to the first embodiment.

FIG. 6 is an explanatory view of a target area selection process according to the first embodiment.

FIG. 7 is an explanatory view of a vector 41 according to the first embodiment.

FIG. 8 is an explanatory view of a primary vector 42 according to the first embodiment.

FIG. 9 is a flowchart of a secondary vector calculation process according to the first embodiment.

FIG. 10 is an explanatory view of a first attention area 38 according to the first embodiment.

FIG. 11 is an explanatory view of a secondary vector 43 according to the first embodiment.

FIG. 12 is a flowchart of a similar area search process according to the first embodiment.

FIG. 13 is an explanatory view of a second attention area 39 according to the first embodiment.

FIG. 14 is an explanatory view of a first attention area 38′ close to the first attention area 38 according to the first embodiment.

FIG. 15 is an explanatory view of the first attention area 38′ close to the first attention area 38 according to the first embodiment.

FIG. 16 is an explanatory view of the first attention area 38′ close to the first attention area 38 according to the first embodiment.

FIG. 17 is an explanatory view of a process of rotating the first map 31 according to the first embodiment.

FIG. 18 is a configuration diagram of a map processing device 10 according to Modification 3.

FIG. 19 is a configuration diagram of a map processing device 10 according to a second embodiment.

FIG. 20 is a flowchart of overall processing of the map processing device 10 according to the second embodiment.

FIG. 21 is a configuration diagram of a map processing device 10 according to a third embodiment.

FIG. 22 is a flowchart of overall processing of the map processing device 10 according to the third embodiment.

### DESCRIPTION OF EMBODIMENTS

### First Embodiment

***Description of Configuration***

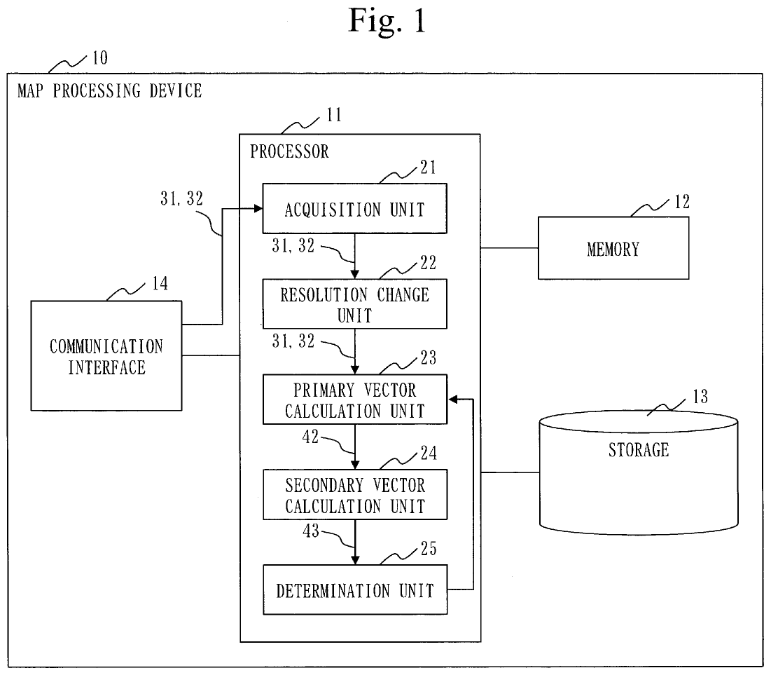

With reference to FIG. 1, a configuration of a map processing device 10 according to a first embodiment will be described.

The map processing device 10 is a computer.

The map processing device 10 includes hardware of a processor 11, a memory 12, a storage 13, and a communication interface 14. The processor 11 is connected to other pieces hardware via a signal line, and controls these other pieces of hardware.

The processor 11 is an integrated circuit (IC) that performs processing. As a specific example, the processor 11 is a central processing unit (CPU), a digital signal processor (DSP), or a graphics processing unit (GPU).

The memory 12 is a storage device that temporarily stores data. As a specific example, the memory 12 is a static random access memory (SRAM) or dynamic random access memory (DRAM).

The storage 13 is a storage device that stores data. As a specific example, the storage 13 is a hard disk drive (HDD). In addition, the storage 13 may be a portable storage medium such as a secure digital (SD, registered trademark) memory card, a compact flash (CF), a NAND flash, a flexible disk, an optical disk, a compact disk, a Blu-Ray (registered trademark) disk, or a digital versatile disk (DVD).

The communication interface 14 is an interface to communicate with external devices. As a specific example, the communication interface 14 is a port of Ethernet (registered trademark), a universal serial bus (USB), or a high-definition multimedia interface (HDMI, registered trademark).

The map processing device 10 includes an acquisition unit 21, a resolution change unit 22, a primary vector calculation unit 23, a secondary vector calculation unit 24, and a determination unit 25 as functional components. A function of each functional component of the map processing device 10 is realized by software.

The storage 13 stores a program for realizing a function of each functional component of the map processing device 10. This program is read into the memory 12 by the processor 11 and executed by the processor 11. This enables realization of a function of each functional component of the map processing device 10.

In FIG. 1, only one processor 11 is illustrated. However, the map processing device 10 may include a plurality of processors substituting for the processor 11. These plurality of processors share execution of a program for realizing a function of each functional component of the map processing device 10. Similarly to the processor 11, each processor is an IC that performs processing.

***Description of Operation***

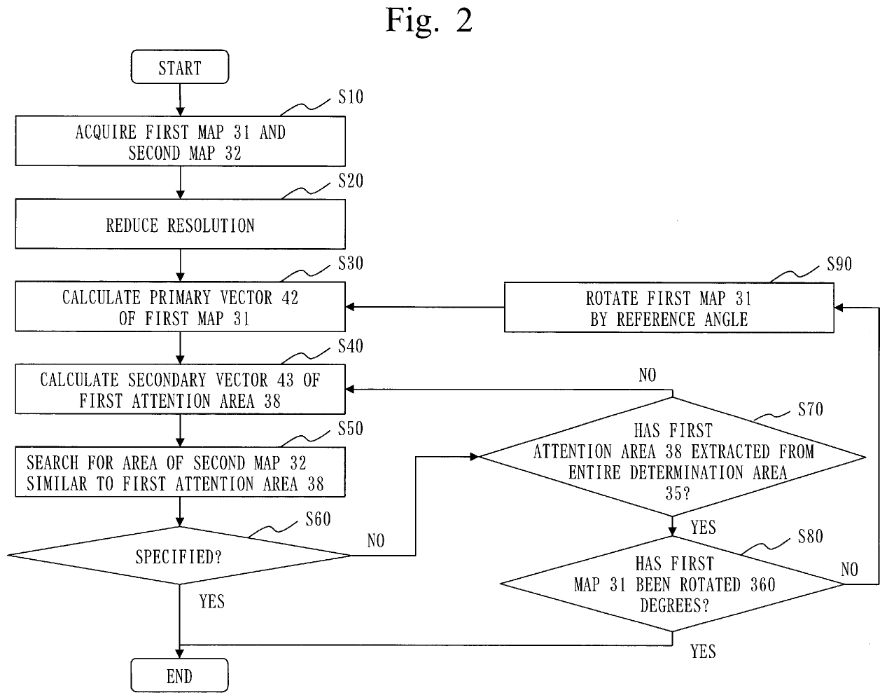

With reference to FIGS. 2 to 17, an operation of the map processing device 10 according to the first embodiment will be described.

The operation of the map processing device 10 according to the first embodiment corresponds to a map processing method according to the first embodiment. Further, the operation of the map processing device 10 according to the first embodiment corresponds to processing of a map processing program according to the first embodiment.

With reference to FIG. 2, overall processing of the map processing device 10 according to the first embodiment will be described.

(Step S10: Acquisition Process)

The acquisition unit 21 acquires a first map 31 and a second map 32 as maps to be synthesized.

Specifically, the acquisition unit 21 acquires the first map 31 and the second map 32 from an external device via the communication interface 14. Alternatively, the acquisition unit 21 acquires the first map 31 and the second map 32 stored in advance in the memory 12 or the storage 13.

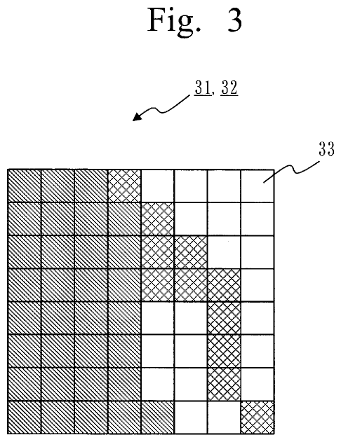

With reference to FIG. 3, the first map 31 and the second map 32 according to the first embodiment will be described.

The first map 31 and the second map 32 are maps indicating existence probability that an object exists in each area 33.

In the first embodiment, as illustrated in FIG. 3, the first map 31 and the second map 32 are occupancy grid maps in which a map range is segmented into a plurality of areas 33 in a grid shape, and existence probability that an object exists in each area 33 is indicated. In the first embodiment, existence probability of each area is any of “1” (occupied) indicating that an object exists, “0” (empty) indicating that an object does not exist, and “0.5” (unknown) indicating that whether an object exists or not is unknown. In FIG. 3, an area with the existence probability “1” is indicated by rhombus hatching, an area with the existence probability “0” is indicated by white, and an area with the existence probability “0.5” is indicated by oblique-line hatching.

The first map 31 is, for example, a map generated by a moving object such as a vehicle. Further, the second map 32 is, for example, a map generated by a peripheral object that is another moving object or the like different from the moving object that has generated the first map 31.

Specifically, the moving object acquires point group data of a surrounding of the moving object by a sensor such as a stereo camera or a laser sensor. Then, from the acquired point group data, the moving object calculates existence probability that an object exists in each area 33 obtained by segmenting the surrounding of the moving object into grids. By the moving object moving and repeatedly performing this processing, the first map 31 is generated. Similarly, by the peripheral object moving and repeatedly performing processing of acquiring point group data and calculating existence probability that an object exists at each position, the second map 32 is generated.

In the first embodiment, it is assumed that a position of each area 33 of the first map 31 and the second map 32 has been specified. As described above, when the first map 31 and the second map 32 are generated by the moving object, a position of each area 33 of the first map 31 and the second map 32 is specified from a position of the moving object specified by a positioning device mounted on the moving object, and from information of the sensor. In the first map 31 and the second map 32, it is assumed that the position of each area 33 is represented in a global coordinate system.

(Step S20: Resolution Change Process)

The resolution change unit 22 reduces resolution of the first map 31 and the second map 32 by making a plurality of areas into one area for the first map 31 and the second map 32.

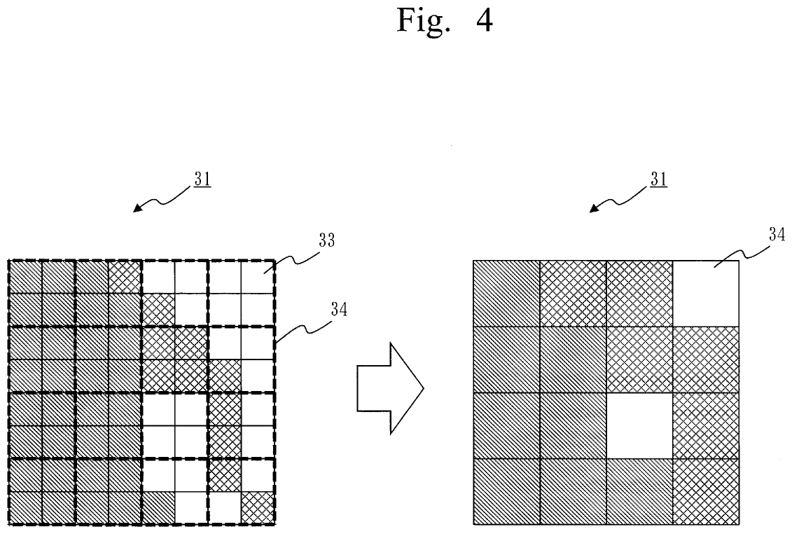

Specific description will be made with reference to FIG. 4. FIG. 4 illustrates an example in which the resolution of the first map 31 is reduced. The resolution of the second map 32 is also reduced by the same method.

The resolution change unit 22 segments individual areas 33 of the first map 31 and the second map 32 into a new area 34 for each designated magnification range from a reference position. In FIG. 4, a total of four areas 33 of two vertical and two horizontal are made into one new area 34. The resolution change unit 22 determines existence probability for each new area 34 as follows. (1) The resolution change unit 22 determines existence probability to be “1” when there is even one area 33 having existence probability of “1”. (2) The resolution change unit 22 determines existence probability to be “0” when existence probability of all the areas 33 is “0”. (3) The resolution change unit 22 determines existence probability to be “0.5” when there is even one area 33 having existence probability of “0.5”.

(Step S30: Primary Vector Calculation Process)

The primary vector calculation unit 23 calculates a primary vector 42 for the first map 31 whose resolution has been reduced in step S20.

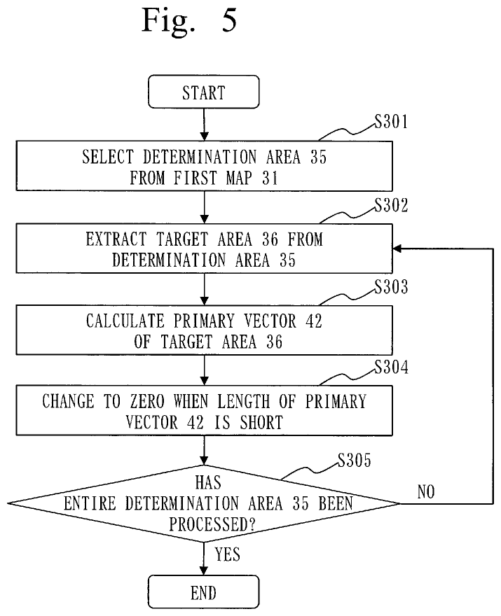

With reference to FIG. 5, a primary vector calculation process according to the first embodiment will be described.

(Step S301: Determination Area Selection Process)

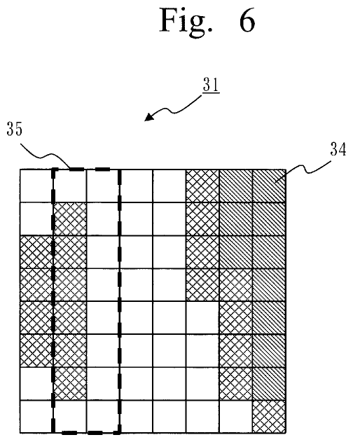

As illustrated in FIG. 6, the primary vector calculation unit 23 selects, as a determination area 35, at least a part of the area 34 of the first map 31 whose resolution has been reduced in step S20.

A position of each area 33 of the first map 31 and the second map 32 has been specified. Therefore, a position of each area 34 has also been specified. Accordingly, the primary vector calculation unit 23 can generally specify, from the position of the area 34, which part of the first map 31 is overlapped with which part of the second map 32. Therefore, the primary vector calculation unit 23 selects, as the determination area 35, a part of the area 34 of the first map 31 that is highly likely to overlap with the second map 32.

Here, the primary vector calculation unit 23 selects the area 34 of a target number from an outer side as the determination area 35, for one side of the rectangular first map 31. In FIG. 6, three areas 34 from an outer side are selected as the determination area 35, for a left side. Note that the area 34 on the outer most side is excluded from the determination area 35 because the primary vector 42 described later cannot be calculated. The target number is determined, for example, by accuracy of the position of the area 34 or the like.

(Step S302: Target Extraction Process)

The primary vector calculation unit 23 extracts one area 34 of the areas 34 selected as the determination area 35 in step S301, as a target area 36.

(Step S303: Vector Calculation Process)

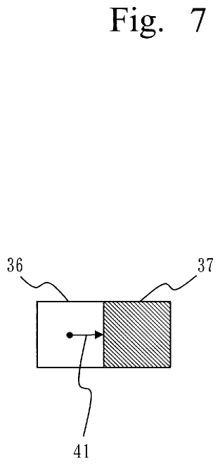

The primary vector calculation unit 23 calculates a difference between existence probability for the target area 36 and existence probability for an adjacent area 37, which is the area 34 adjacent to the target area 36, as a vector 41 for the target area 36 with respect to the adjacent area 37. As a specific example, as illustrated in FIG. 7, it is assumed that the existence probability of the target area 36 is “0”, and the existence probability of the adjacent area 37 is “0.5”. In this case, the vector 41 for the target area 36 with respect to the adjacent area 37 is a vector with a length of 0.5 in a direction from the target area 36 toward the adjacent area 37.

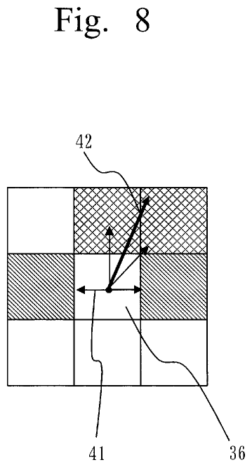

As illustrated in FIG. 8, the primary vector calculation unit 23 calculates the sum of the vectors 41 for the target area 36 with respect to eight surrounding areas 34 as the primary vector 42 of the target area 36. That is, the primary vector calculation unit 23 calculates the primary vector 42, by Formula 1.

\vec{b}₀=Σᵢ₌₋₁¹Σⱼ₌₋₁¹(\vec{a}ᵢⱼ−\vec{a}₀) [Formula 1]

In Formula 1, a vector a\vec{ }₀ is the existence probability of the target area 36. A vector a\vec{ }ᵢⱼ is the existence probability of the adjacent area 37. A variable i represents a position of the area 34 in a horizontal direction, and a variable j represents a position of the area 34 in a vertical direction. Therefore, the vector 41 is (a\vec{ }ᵢⱼ−a\vec{ }₀). A vector b\vec{ }₀ is the primary vector 42 of the target area 36.

(Step S304: Rounding Process)

When a length of the primary vector 42 calculated in step S302 is shorter than a primary threshold, the primary vector calculation unit 23 changes the primary vector 42 to zero.

(Step S305: End Determination Process)

The primary vector calculation unit 23 determines whether or not the primary vector 42 has been calculated for all the areas 34 selected as the determination area 35 in step S301.

When the primary vector 42 has been calculated for all the areas 34, the primary vector calculation unit 23 ends the process. Whereas, otherwise, the primary vector calculation unit 23 returns the process to step S302.

(Step S40: Secondary Vector Calculation Process)

The secondary vector calculation unit 24 calculates a secondary vector 43 for the first map 31 whose resolution has been reduced in step S20.

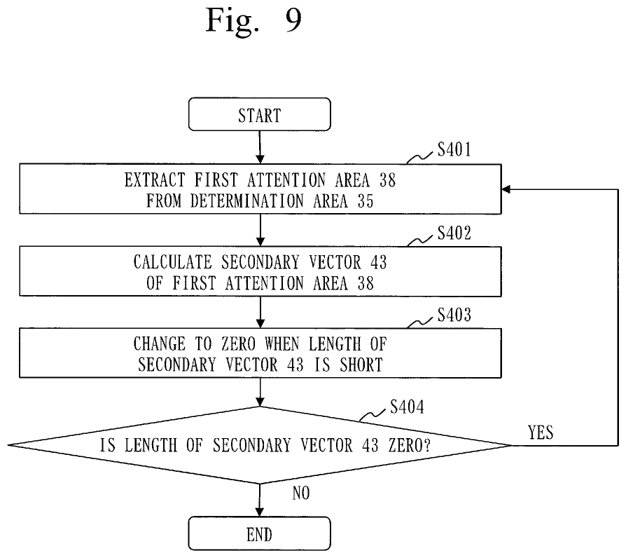

With reference to FIG. 9, a secondary vector calculation process according to the first embodiment will be described.

(Step S401: Attention Area Extraction Process)

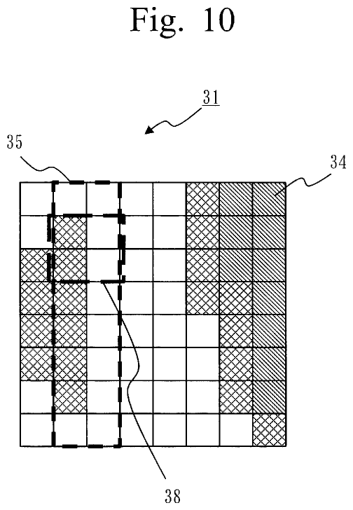

As illustrated in FIG. 10, the secondary vector calculation unit 24 extracts, as a first attention area 38, two or more adjacent areas 34 from the areas 34 selected as the determination area 35 in step S301. In FIG. 10, a total of four areas 34 of two vertical and two horizontal are extracted as the first attention area 38.

(Step S402: Vector Calculation Process)

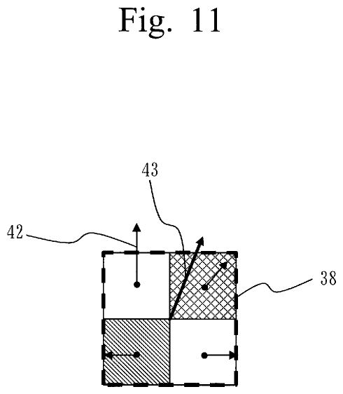

As illustrated in FIG. 11, the secondary vector calculation unit 24 calculates, as the secondary vector 43, the sum of the primary vectors 42 for the individual areas 34 included in the first attention area 38 extracted in step S401. That is, the secondary vector calculation unit 24 synthesizes the primary vectors 42 for individual areas 34 to calculate the secondary vector 43, by Formula 2.

\vec{b}=ΣᵢΣⱼ\vec{b}ᵢⱼ [Formula 2]

In Formula 2, a vector bᵢⱼ is the primary vector 42 of each area 34. A variable i represents a position of the area 34 in a horizontal direction, and a variable j represents a position of the area 34 in a vertical direction. A range of the variables i and j is a range of the first attention area 38. A vector b is the secondary vector 43.

(Step S403: Rounding Process)

When a length of the secondary vector 43 calculated in step S402 is shorter than a secondary threshold, the secondary vector calculation unit 24 changes the secondary vector 43 to zero.

(Step S404: End Determination Process)

The secondary vector calculation unit 24 determines whether a length of the secondary vector 43 is zero.

When the length of the secondary vector 43 is zero, the secondary vector calculation unit 24 returns the process to step S401 to extract another first attention area 38. Whereas, otherwise, the secondary vector calculation unit 24 ends the process.

(Step S50: Similar Area Search Process)

The determination unit 25 searches for an area of the second map 32 having a high degree of similarity with the first attention area 38 extracted in step S401.

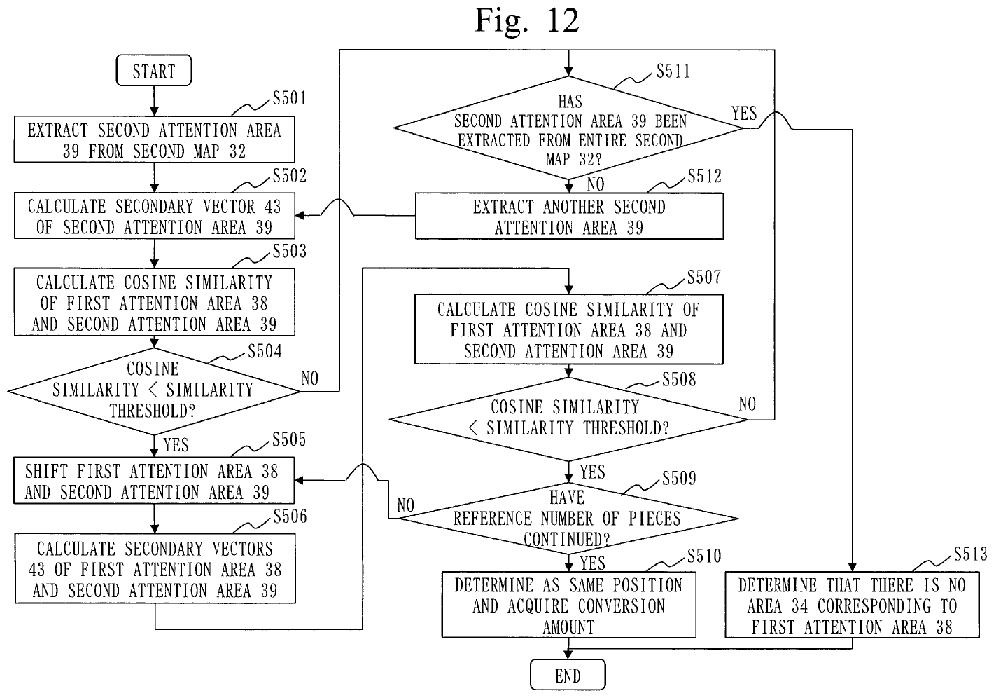

With reference to FIG. 12, a similar area search process according to the first embodiment will be described.

(Step S501: Attention Area Extraction Process)

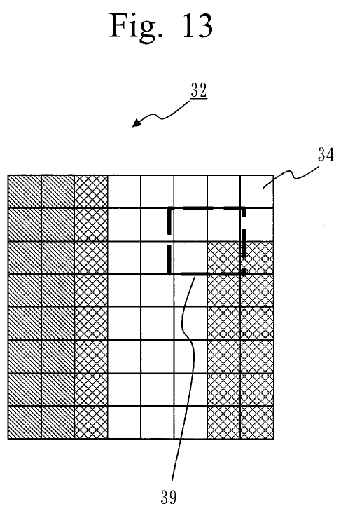

As illustrated in FIG. 13, the determination unit 25 extracts two or more adjacent areas 34 as a second attention area 39, from the second map 32 whose resolution has been reduced in step S20. The second attention area 39 extracted here has the same size as that of the first attention area 38 extracted in step S401. That is, the second attention area 39 extracted here and the first attention area 38 extracted in step S401 have the same number of areas 34 included in the vertical direction and the same number of areas 34 included in the horizontal direction.

(Step S502: First Vector Calculation Process)

The determination unit 25 causes the primary vector calculation unit 23 and the secondary vector calculation unit 24 to calculate the secondary vector 43 for the second attention area 39 extracted in step S501.

A calculation method of the secondary vector 43 is as described above. That is, first, the primary vector calculation unit 23 calculates the primary vector 42 of each area 34 included in the second attention area 39. That is, the primary vector calculation unit 23 calculates the sum of the vectors 41 for the target area 36 with respect to eight surrounding areas 34 as the primary vector 42 of the target area 36, with each area 34 as the target area 36. Then, the secondary vector calculation unit 24 calculates the sum of the primary vectors 42 for the individual areas 34 included in the second attention area 39, as the secondary vector 43.

(Step S503: First Similarity Calculation Process)

The determination unit 25 calculates cosine similarity between the secondary vector 43 for the first attention area 38 calculated in step S402 and the secondary vector 43 for the second attention area 39 calculated in step S502.

Specifically, the determination unit 25 calculates cosine similarity between the secondary vector 43 for the first attention area 38 and the secondary vector 43 for the second attention area 39, by Formula 3.

cos(\vec{A},\vec{B})=\vec{A}·\vec{B})/(|\vec{A}∥\vec{B}|) [Formula 3]

In Formula 3, the vector A\vec{ } is the secondary vector 43 for the first attention area 38. The vector Bis the secondary vector 43 for the second attention area 39. cos (A\vec{ }, B\vec{ }) is cosine similarity between the secondary vector 43 for the first attention area 38 and the secondary vector 43 for the second attention area 39.

(Step S504: First Similarity Determination Process)

The determination unit 25 determines whether cosine similarity calculated in step S504 is smaller than a similarity threshold.

When the cosine similarity is smaller than the similarity threshold, the determination unit 25 advances the process to step S505, while assuming that the first attention area 38 and the second attention area 39 correspond to each other. At this time, 1 is set to a variable k. Whereas, otherwise, the process proceeds to step S511. At this time, 0 is set to the variable k.

(Step S505: Area Shift Process)

From the first map 31 whose resolution has been reduced in step S2, the determination unit 25 extracts another first attention area 38 (here, this will be referred to as a first attention area 38′ for convenience) close to the first attention area 38 in a reference direction. Further, from the second map 32 whose resolution has been reduced in step S20, the determination unit 25 extracts another second attention area 39 (here, this will be referred to as a second attention area 39′ for convenience) close to the second attention area 39 in a reference direction.

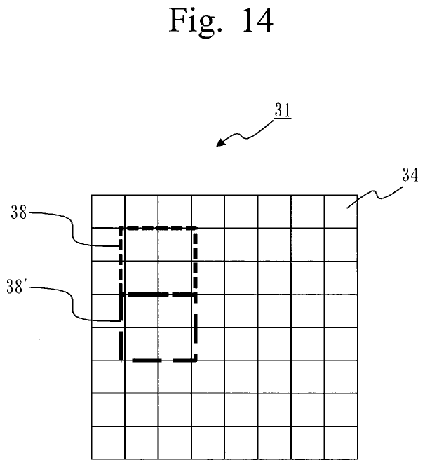

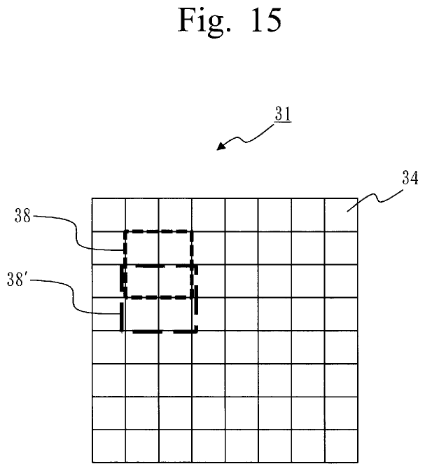

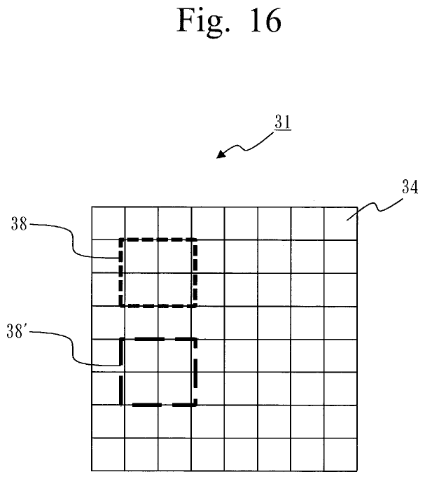

As illustrated in FIG. 14, the first attention area 38′ close to the first attention area 38 may be the first attention area 38′ adjacent to the first attention area 38. In addition, as illustrated in FIG. 15, the first attention area 38′ close to the first attention area 38 may have a part overlapped. Further, as illustrated in FIG. 16, the first attention area 38′ close to the first attention area 38 may have a space in between. The same applies to the second attention area 39′ close to the second attention area 39.

However, the positional relationship between the first attention area 38 and the first attention area 38′ and the positional relationship between the second attention area 39 and the second attention area 39′ are the same. That is, if the first attention area 38′ is below and adjacent to the first attention area 38, the second attention area 39′ is also below and adjacent to the second attention area 39.

(Step S506: Second Vector Calculation Process)

The determination unit 25 causes the primary vector calculation unit 23 and the secondary vector calculation unit 24 to calculate the secondary vectors 43 for the first attention area 38 and the second attention area 39 extracted in step S505.

A calculation method of the secondary vector 43 is as described above. That is, first, the primary vector calculation unit 23 calculates the primary vector 42 of each area 34 included in the first attention area 38. That is, the primary vector calculation unit 23 calculates the sum of the vectors 41 for the target area 36 with respect to eight surrounding areas 34 as the primary vector 42 of the target area 36, with each area 34 as the target area 36. Then, the secondary vector calculation unit 24 calculates the sum of the primary vectors 42 for the individual areas 34 included in the first attention area 38, as the secondary vector 43. A similar process is performed on the second attention area 39, to calculate the secondary vector 43.

(Step S507: Second Similarity Calculation Process)

The determination unit 25 calculates cosine similarity between the secondary vector 43 for the first attention area 38 and the secondary vector 43 for the second attention area 39 calculated in step S506.

A calculation method of cosine similarity is the same as step S503.

(Step S508: Second Similarity Determination Process)

The determination unit 25 determines whether or not cosine similarity calculated in step S507 is smaller than a similarity threshold.

When the cosine similarity is smaller than the similarity threshold, the determination unit 25 advances the process to step S509, while assuming that the first attention area 38 extracted in step S505 corresponds to the second attention area 39 extracted in step S505. At this time, 1 is added to the variable k. Whereas, otherwise, the process proceeds to step S511. At this time, 0 is set to the variable k.

(Step S509: Continuation Determination Process)

The determination unit 25 determines whether or not the variable k is a reference number N. In other words, the determination unit 25 determines whether or not the reference number of pieces (N pieces) of the first attention area 38 and the second attention area 39 correspond continuously.

When the variable k is the reference number N, the determination unit 25 advances the process to step S510. Whereas, otherwise, the determination unit 25 returns the process to step S505.

(Step S510: Matching Process)

The determination unit 25 determines that the reference number of pieces of the first attention area 38 in proximity for the first map 31 and the reference number of pieces of the second attention area 39 in proximity for the second map 32 indicate a same position. Then, the determination unit 25 obtains a conversion amount for associating the first map 31 and the second map 32, from positional relationship between the first attention area 38 and the second attention area 39 determined to indicate the same position.

Specifically, the conversion amount includes a movement amount for translating the map in parallel and a rotation amount for rotating the map. The movement amount corresponds to a positional shift between the first attention area 38 and the second attention area 39 determined to indicate the same position. Further, the rotation amount corresponds to an angle at which the first map 31 is rotated in step S90 described later.

(Step S511: Second Area Determination Process)

The determination unit 25 determines whether or not all the areas of the second map 32 have been extracted as the second attention area 39.

When all the areas have been extracted, the determination unit 25 advances the process to step S513. Whereas, otherwise, the determination unit 25 advances the process to step S512.

(Step S512: Proximity Area Extraction Process)

The determination unit 25 extracts another second attention area 39 close to the second attention area 39, from the second map 32 whose resolution has been reduced in step S20. Then, the determination unit 25 returns the process to step S502.

(Step S513: Non-Constant Process)

The determination unit 25 determines that the area 34 corresponding to the first attention area 38 selected in step S401 is not in the second map 32. That is, it is determined that the area 34 indicating the same position as the first attention area 38 selected in step S401 is not in the second map 32.

(Step S60: End Determination Process)

In step S50, the determination unit 25 determines whether or not an area of the second map 32 having a high degree of similarity with the first attention area 38 extracted in step S401 has been specified.

When the area of the second map 32 having a high degree of similarity has been specified, the determination unit 25 ends the process. Otherwise, the determination unit 25 advances the process to step S70.

(Step S70: First Area Determination Process)

The determination unit 25 determines whether or not all the areas 34 included in the determination area 35 have been selected as the first attention area 38 in step S401.

When all the areas 34 have not been selected as the first attention area 38, the determination unit 25 returns the process to step S40 to cause selection of a new first attention area 38. Whereas, otherwise, the determination unit 25 advances the process to step S80.

(Step S80: End Determination Process)

The determination unit 25 determines whether or not the first map 31 has been rotated 360 degrees.

When the first map 31 has been rotated 360 degrees, the determination unit 25 determines that the first map 31 and the second map 32 do not overlap, and ends the process. Whereas, otherwise, the determination unit 25 advances the process to step S90.

(Step S90: Map Rotation Process)

The determination unit 25 rotates the first map 31 by a reference angle. Then, the determination unit 25 returns the process to step S30 to cause calculation of the primary vector 42 of the first map 31 again.

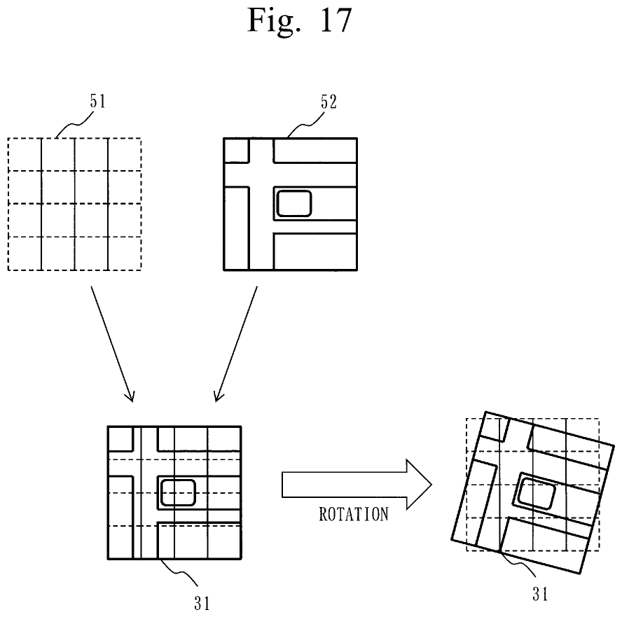

With reference to FIG. 17, a process of rotating the first map 31 will be described.

Here, it is considered that the first map 31 is made of a frame layer 51 defining the area 33 and a map layer 52 on which existence probability is indicated. Rotating the first map 31 is to rotate only the map layer 52 without rotating the frame layer 51.

That is, it is assumed that coordinates before rotation are (X0, Y0), rotation center coordinates are (CX, CY), coordinates after rotation are (X1, Y1), and a rotation angle is θ. Then, rotating the first map 31 is the calculation indicated in Formula 4. That is, rotating the first map 31 is to calculate, from the coordinates of the area 33 after rotation, the coordinates of the area 33 before rotation corresponding to the area 33, and set existence probability of the area 33 before rotation as existence probability of the area 33 after rotation.

$$( \begin{matrix}{X}_{0} - {C}_{x} \\ {Y}_{0} - {C}_{y}\end{matrix} ) = ( \begin{matrix}cos ( - θ ) & - sin ( - θ ) \\ sin ( - θ ) & cos ( - θ )\end{matrix} ) ( \begin{matrix}{X}_{1} - {C}_{x} \\ {Y}_{1} - {C}_{y}\end{matrix} ) \qquad [ Formula 4 ]$$

***Effect of First Embodiment***

As described above, the map processing device 10 according to the first embodiment specifies corresponding points of the first map 31 and the second map 32, by comparing the vector 41 by cosine similarity while using, as the vector 41, a difference of existence probability that an object exists in each area 34.

Since the calculation is performed using the vector 41, a processing time can be shortened as compared with a case where a histogram is used as in Patent Literature 1. Further, even when there is a moving object, an influence of the movement on the vector 41 is small. Therefore, even when there is a moving object, it is possible to accurately specify the corresponding points of the first map 31 and the second map 32.

***Other Configuration***

<Modification 1>

In the first embodiment, two maps of the first map 31 and the second map 32 are acquired in step S10 of FIG. 2. However, three or more maps may be acquired in step S10 of FIG. 2. In this case, the map processing device 10 may simply execute the processing after step 2 in FIG. 2 for each combination of two maps.

<Modification 2>

In the first embodiment, existence probability of any of “1”, “0”, and “0.5” is set in each area 33 of the first map 31 and the second map 32. However, without limiting to this, probability may be set more finely in each area 33.

In this case, in step S20 of FIG. 2, the resolution change unit 22 may simply set the highest probability among the probabilities of the areas 33 included in the new area 34, as the probability of the new area 34.

<Modification 3>

In the first embodiment, a function of each functional component of the map processing device 10 is realized by software. As a third modification, a function of each functional component of the map processing device 10 may be realized by hardware. With regard to Modification 3, points different from the first embodiment will be described.

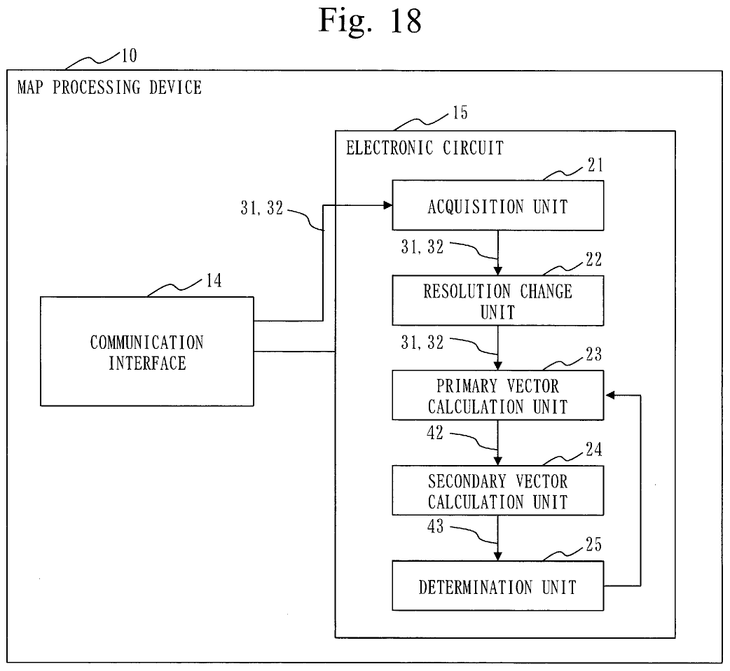

With reference to FIG. 18, a configuration of the map processing device 10 according to Modification 3 will be described.

In a case where a function of each functional component is realized by hardware, the map processing device 10 includes a communication interface 14 and an electronic circuit 15. The electronic circuit 15 is a dedicated electronic circuit that realizes a function of each functional component of the map processing device 10 and functions of the memory 12 and the storage 13.

For the electronic circuit 15, a single circuit, a composite circuit, a programmed processor, a parallel programmed processor, a logic IC, a gate array (GA), an application specific integrated circuit (ASIC), or a field-programmable gate array (FPGA) is assumed.

A function of each functional component may be realized by one electronic circuit 15, or a function of each functional component may be distributed to a plurality of electronic circuits 15 to be realized.

<Modification 4>

In Modification 4, some function may be realized by hardware, and other function may be realized by software. That is, in each functional component of the map processing device 10, some function may be realized by hardware, and other function may be realized by software.

The processor 11, the storage device 12, and the electronic circuit 15 are referred to as processing circuitry. That is, even when the map processing device 10 is configured as illustrated in either FIG. 1 or FIG. 18, a function of each functional component is realized by the processing circuitry.

### Second Embodiment

A second embodiment differs from the first embodiment in that a first map 31 and a second map 32 are synthesized. In the second embodiment, this difference will be described, and the description of same points will be omitted.

***Description of Configuration***

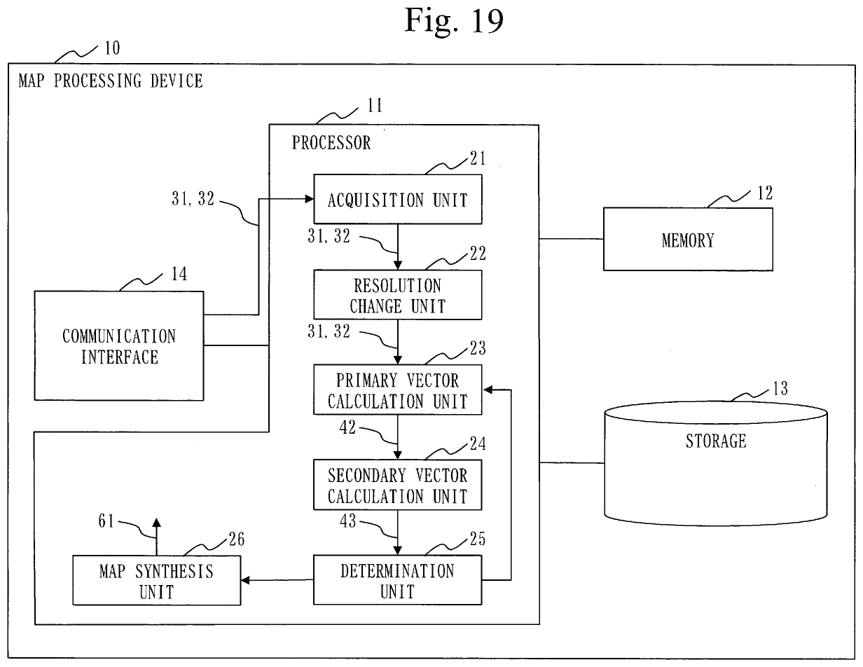

With reference to FIG. 19, a configuration of a map processing device 10 according to the second embodiment will be described.

The map processing device 10 differs from the map processing device 10 illustrated in FIG. 1 in that a map synthesis unit 26 is provided. The map synthesis unit 26 is realized by software similarly to other functional components. Alternatively, the map synthesis unit 26 may be realized by hardware.

***Description of Operation***

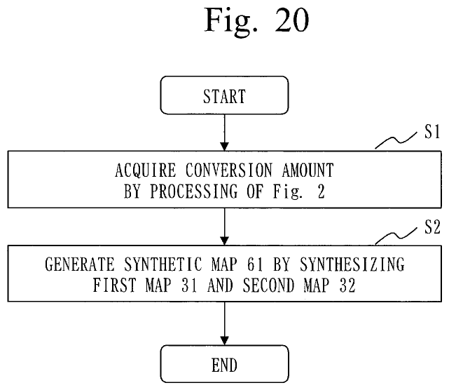

With reference to FIG. 20, an operation of the map processing device 10 according to the second embodiment will be described.

(Step S1: Map Comparison Process)

The map processing device 10 executes the process described on the basis of FIG. 2, to calculate a conversion amount for synthesizing the first map 31 and the second map 32.

(Step S2: Synthesis Process)

The map synthesis unit 26 synthesizes the first map 31 and the second map 32 on the basis of the conversion amount calculated in step S1, to generate a synthetic map 61.

Specifically, the map synthesis unit 26 converts the second map 32 on the basis of the conversion amount. Then, the map synthesis unit 26 synthesizes the first map 31 and the converted second map 32 to generate the synthetic map 61.

When synthesizing the first map 31 and the converted second map 32, the map synthesis unit 26 adds a portion of the second map 32 not included in the first map 31, to the first map 31. For a portion included in both the first map 31 and the second map 32, the map synthesis unit 26 may use either one of the first map 31 and the second map 32, or may average the first map 31 and the second map 32, and the like.

***Effect of Second Embodiment***

As described above, the map processing device 10 according to the second embodiment synthesizes the first map 31 and the second map 32. As described in the first embodiment, the map processing device 10 can accurately specify corresponding points of the first map 31 and the second map 32 in a short processing time. Therefore, the map processing device 10 can accurately generate the synthetic map 61 obtained by synthesizing the first map 31 and the second map 32 in a short processing time.

### Third Embodiment

A third embodiment differs from the second embodiment in that driving support is performed on the basis of a synthetic map 61. In the third embodiment, this difference will be described, and the description of same points will be omitted.

***Description of Configuration***

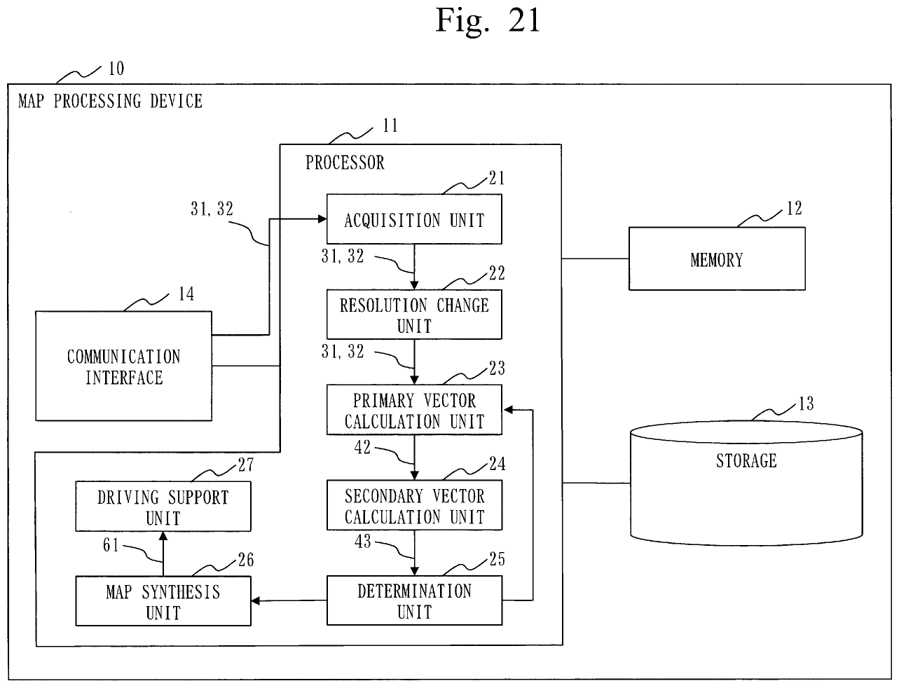

With reference to FIG. 21, a configuration of a map processing device 10 according to the third embodiment will be described.

The map processing device 10 differs from the map processing device 10 illustrated in FIG. 19 in that a driving support unit 27 is provided. The driving support unit 27 is realized by software similarly to other functional components. Alternatively, the driving support unit 27 may be realized by hardware.

***Description of Operation***

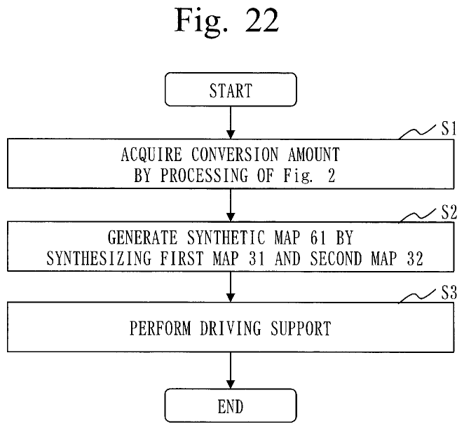

With reference to FIG. 22, an operation of the map processing device 10 according to the third embodiment will be described.

The processing from step S1 to step S2 is the same as in the second embodiment.

(Step S3: Driving Support Process)

The driving support unit 27 performs driving support of a moving object on the basis of the synthetic map 61. Specifically, the driving support unit 27 controls the moving object on the basis of the synthetic map 61 to realize automatic driving. Alternatively, the driving support unit 27 provides a driver of the moving object with information of the synthetic map 61. For example, the driving support unit 27 provides information of the synthetic map 61 to the driver of the moving object by displaying the information of the synthetic map 61 on a display device mounted on the moving object.

***Effect of Third Embodiment***

As described above, the map processing device 10 according to the third embodiment performs driving support on the basis of the synthetic map 61. As described in the second embodiment, the map processing device 10 can accurately generate the synthetic map 61 in a short processing time. Therefore, the map processing device 10 can perform driving support with high real-time performance on the basis of the synthetic map 61 with high accuracy.

***Other Configuration***

<Modification 5>

In the third embodiment, the map processing device 10 includes the driving support unit 27. However, the driving support unit 27 may be provided to a driving support device different from the map processing device 10. In this case, the driving support device performs driving support by acquiring the synthetic map 61 generated in step S2 of FIG. 22, from the map processing device 10.

### REFERENCE SIGNS LIST

10: map processing device, 11: processor, 12: memory, 13: storage, 14: communication interface, 15: electronic circuit, 21: acquisition unit, 22: resolution change unit, 23: primary vector calculation unit, 24: secondary vector calculation unit, 25: determination unit, 26: map synthesis unit, 27: driving support unit, 31: first map, 32: second map, 33: area, 34: area, 35: determination area, 36: target area, 37: adjacent area, 38: first attention area, 39: second attention area, 41: vector, 42: primary vector, 43: secondary vector, 51: layer, 52: layer, 61: synthetic map.

1. A map processing device comprising:
processing circuitry to:
calculate a sum of a vector for a target area with respect to a surrounding area as a primary vector of the target area, for each of a first map and a second map indicating existence probability that an object exists in each area with at least a part of an area as the target area, by using a difference between the existence probability for the target area and the existence probability for an adjacent area adjacent to the target area as a vector for the target area with respect to the adjacent area,
calculate a sum of the primary vector of each area included in an attention area as a secondary vector of the attention area, for each of the first map and the second map with two or more areas as the attention area, and
compare the secondary vector calculated for the attention area for the first map and the secondary vector calculated for the attention area for the second map, to determine whether or not the attention area for the first map corresponds to the attention area for the second map.

2. The map processing device according to claim 1, wherein
in a case where a reference number of pieces of the attention area in proximity for the first map correspond to a reference number of pieces of the attention area in proximity for the second map, the processing circuitry determines that the reference number of pieces of the attention area in proximity for the first map and that the reference number of pieces of the attention area in proximity for the second map indicate a same position.

3. The map processing device according to claim 2, wherein
the processing circuitry determines whether or not the reference number of pieces of the attention area in proximity in a reference direction for the first map correspond to the reference number of pieces of the attention area in proximity for the second map, while rotating the first map by a reference angle.

4. The map processing device according to claim 1, wherein
the processing circuitry compares by calculating cosine similarity of the secondary vector calculated for the attention area for the first map and the secondary vector calculated for the attention area for the second map.

5. The map processing device according to claim 1, wherein
the processing circuitry selects from a second area from an outer side to an area of a target number towards an inner side as the target area, for each of the first map and the second map.

6. The map processing device according to claim 1, wherein
the processing circuitry sets the primary vector of the target area to zero when a sum of a vector for the target area with respect to a surrounding area is smaller than a first threshold,
sets the secondary vector of the attention area to zero when a sum of the primary vector of each area included in the attention area is smaller than a second threshold, and
compares for the attention area in which the secondary vector is not zero.

7. The map processing device according to claim 1, wherein
the processing circuitry reduces resolution of the first map and the second map by making a plurality of areas into one area for the first map and the second map, and
calculates the primary vector for the first map and the second map whose resolution has been reduced.

8. The map processing device according to claim 7, wherein
the processing circuitry sets highest existence probability among the existing probabilities for the plurality of areas each, as the existence probability for the one area.

9. The map processing device according to claim 1, wherein
the processing circuitry synthesizes the first map and the second map to generate a synthetic map based on the attention area determined to correspond, and
controls a moving object, or provides a driver of the moving object with information, based on the generated synthetic map.

10. A map processing method comprising:
calculating a sum of a vector for a target area with respect to a surrounding area as a primary vector of the target area, for each of a first map and a second map indicating existence probability that an object exists in each area with at least a part of an area as the target area, by using a difference between the existence probability for the target area and the existence probability for an adjacent area adjacent to the target area as a vector for the target area with respect to the adjacent area;
calculating a sum of the primary vector of each area included in an attention area as a secondary vector of the attention area, for each of the first map and the second map with two or more areas as the attention area; and
comparing the secondary vector calculated for the attention area for the first map and the secondary vector calculated for the attention area for the second map, to determine whether or not the attention area for the first map corresponds to the attention area for the second map.

11. A non-transitory computer readable medium storing a map processing program for causing a computer to execute:
a primary vector calculation process of calculating a sum of a vector for a target area with respect to a surrounding area as a primary vector of the target area, for each of a first map and a second map indicating existence probability that an object exists in each area with at least a part of an area as the target area, by using a difference between the existence probability for the target area and the existence probability for an adjacent area adjacent to the target area as a vector for the target area with respect to the adjacent area;
a secondary vector calculation process of calculating a sum of the primary vector of each area included in an attention area as a secondary vector of the attention area, for each of the first map and the second map with two or more areas as the attention area; and
a determination process of comparing the secondary vector calculated for the attention area for the first map and the secondary vector calculated for the attention area for the second map, to determine whether or not the attention area for the first map corresponds to the attention area for the second map.
